(19) United States
(12) Patent Application Publication
(10) Pub. No.: US 2023/0208920 A1
(43) Pub. Date: Jun. 29, 2023

(54) BRIDGING COMMUNICATIONS BETWEEN APPLICATIONS IN DIFFERENT ENVIRONMENTS

(71) Applicant: OpenFin Inc., New York, NY (US)

(72) Inventors: Chuck Doerr, New York, NY (US); Wenjun Che, New York, NY (US)

(21) Appl. No.: 17/560,849

(22) Filed: Dec. 23, 2021

(51) Int. Cl. H04L 67/141; H04L 67/10

(52) U.S. Cl. CPC H04L 67/141; H04L 67/10

(57) ABSTRACT

A method of communicating between applications is provided. The method includes determining that a communication bridge should be established between a first application located within a first computing environment and a second application within a second computing environment. The communication bridge comprises a set of communication channels. The method also includes establishing the communication bridge between the first application and the second application. The method further includes determining that the first application should communicate data with the second application. The method further includes identifying a first communication channel from the set of communication channels based on the determination that the first application should communicate data with the second application. The method further includes communicating data between the first application and the second application via the first communication channel.

### BACKGROUND

An application may operate or execute on a computing device to perform various functions, operations, method, etc. For example, an application may allow a user to place an order, send a message, debit money from an account, send an email, etc. Often, one application may use another application to perform other functions. For example, a first application may be used to place an order and a second application may be used to update an inventory database.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments without departing from the spirit and scope of the described embodiments.

FIG. 1 is a block diagram that illustrates an example of a system architecture, in accordance with some embodiments of the present disclosure.

FIG. 2 is a diagram that illustrates an example communication bridge, in accordance with some embodiments of the present disclosure.

FIG. 3 illustrates an example sequence diagram which illustrates operations that may be performed one or more bridge components, in accordance with some embodiments of the present disclosure.

FIG. 4 is a flow diagram of a method to communicate data between applications, in accordance with some embodiments of the present disclosure.

FIG. 5 is a block diagram of an example apparatus that may perform one or more of the operations described herein, in accordance with some embodiments of the present disclosure.

### DETAILED DESCRIPTION

As discussed above, an application may operate or execute on a computing device to perform various functions, operations, method, etc. One application may use one or more other applications to perform other functions. Some applications may require particular environments to operate properly (e.g., may require specific devices, networks, services, etc.). Generally, for two applications which use different environments to operate correctly, the applications should be located within a same environment and the same environment should provide the resources, devices, etc., of each of the environments needed by the applications. However, duplicating one environment inside of another environment may be time consuming, complicated, and/or expensive process/operation. In addition, creating a combined environment that duplicates both a first environment and a second environment is also expensive, time consuming, and complicated.

The embodiments, implementations, and/or examples described herein provide a communication bridge that may allow the operations and/or interactions of application 112 and 122 to be tested without creating a combined environment or duplicating one environment within another environment. The communicating bridge may allow each application to execute within its own separate environment but still communicate with each other via API function calls. This allows the separate applications to operate as if they were within the same environment and/or computing device.

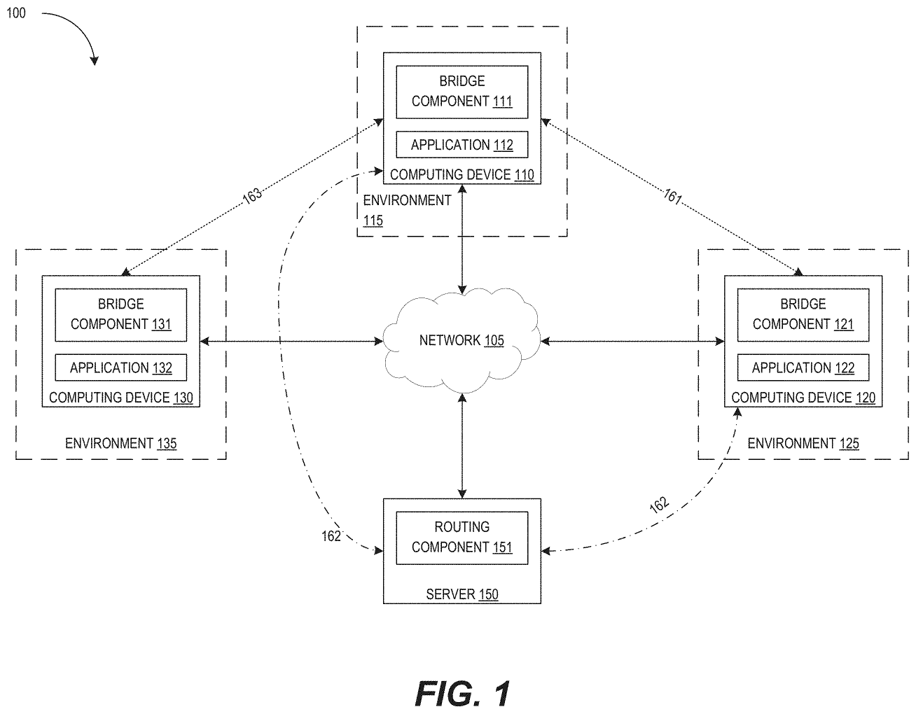

FIG. 1 is a block diagram that illustrates an example of a system architecture 100, in accordance with some embodiments of the present disclosure. The system architecture 100 may include a computing device 110, computing device 120, computing device 130 and server 150. Although three computing devices are illustrated in FIG. 1, there may be more or fewer computing devices in other embodiments of the system architecture 100. Network 105 may be a public network (e.g., the internet), a private network (e.g., a local area network (LAN) or wide area network (WAN)), or a combination thereof. In various embodiments, the network 105 may include a wired or a wireless infrastructure, such as a WiFi™ hotspot connected with the network 105, and/or a wireless carrier system that can be implemented using various data processing equipment, communication towers (e.g. cell towers), etc. In embodiments, the network 105 may utilize any protocol or combination of protocols for communicating data between the computing device 110, computing device 120, computing device 130, and server 150, such as Ethernet, internet protocol (IP), etc. The system architecture 100 may be a cloud-based service, on an organization's network, a stand-alone on a desktop, or at any other location connectable to one or more computing devices, such as computing device 110.

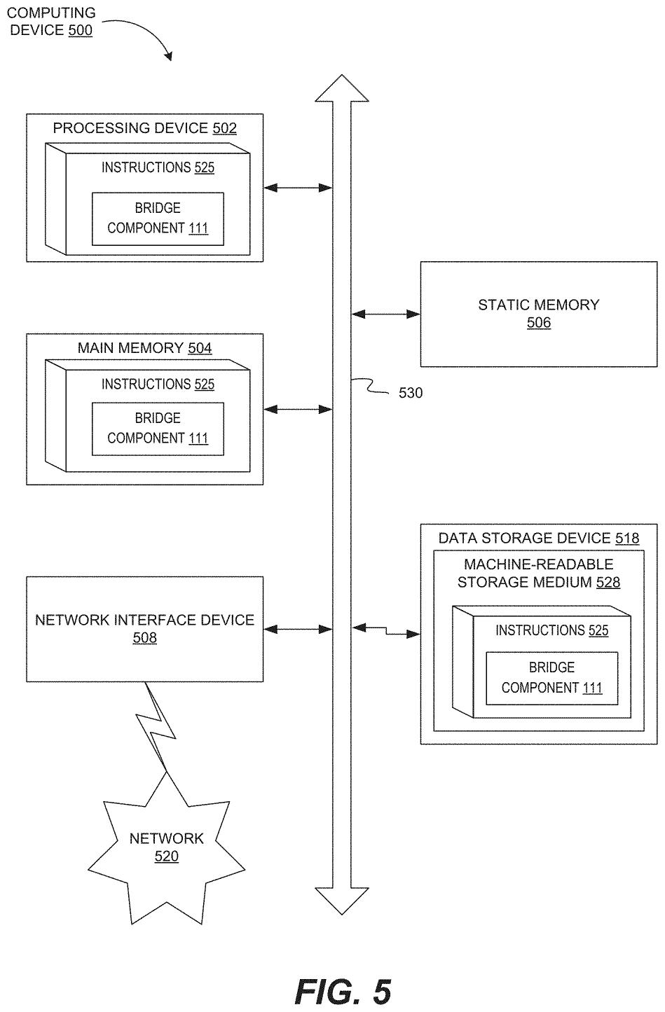

Each of the computing devices 110, 120, and 130 may include hardware such as a processing device, memory, and other hardware devices (e.g., sound card, video card, etc.) (not shown). Similarly, server 150 may include hardware such as processing devices, and respective memories, and other respective hardware devices (e.g., sound card, video card, etc.) (not shown). The processing devices, and the memories may be any one or combination of processing devices and memories discussed below with respect to FIG. 5. In an illustrative example, processing devices may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing devices may also include one or more special-purpose processing devices such as an application specific integrated circuit (ASIC), a field programmable gate array (FPGA), a digital signal processor (DSP), network processor, or the like.

Each of the computing devices 110, 120, and 130, and server 150 may include any suitable type of device or machine that has one or more processing devices including, for example, server computers, desktop computers, laptop computers, tablet computers, smartphones, set-top boxes, etc. In some examples, a computing device may comprise a single machine, virtual machines running on one or more machines, or may include multiple interconnected real or virtual machines (e.g., multiple nodes in a cluster). The computing devices 110, 120, and 130, and/or server 150 may be implemented by a common entity or may be implemented by different entities. For example, computing device 110 may be operated by a first entity, computing device 120 may be operated by a second entity, computing device 130 may be operated by a third entity, and server 150 may be operated by a fourth entity.

Application 112 is located on computing device 110. Application 112 and computing device 110 are located within environment 115. The environment 115 may include devices (e.g., server computers, peripheral devices, computing devices, etc.), software, networks, etc., that are used by the application 112. For example, special servers and network equipment may be used in the environment 115 to allow the application 112 to perform or operate correctly. Similarly, application 122 is located on computing device 120. Application 122 and computing device 120 are located within environment 125. The environment 125 may include devices (e.g., server computers, peripheral devices, computing devices, etc.), software, networks, etc., that are used by the application 122. For example, special servers and network equipment may be used in the environment 125 to allow the application 122 to perform or operate correctly. In addition, application 132 is located on computing device 130. Application 132 and computing device 130 are located within environment 135. The environment 135 may include devices (e.g., server computers, peripheral devices, computing devices, etc.), software, networks, etc., that are used by the application 132. For example, special servers and network equipment may be used in the environment 135 to allow the application 132 to perform or operate correctly. The environments 115, 125, and 135 may be referred to as operating environments, computing environments, system environments, network environments, etc.

As discussed above, the applications 112 and 122 may need to communicate with each other and/or exchange data to perform various functions. However, the applications 112 and 122 may be located with different environments (e.g., environments 115 and 125 respectively). In addition, applications 112 and 122 may not be able to operate or execute properly (e.g., perform various functions) outside of their respective environments.

Generally, for applications 112 and 122 to operate correctly, the applications 112 and 122 should be located within a same environment and the same environment should provide the resources, devices, etc., of environment 115 and 125. However, duplicating one environment inside of another environment (e.g., duplicating environment 125 within environment 115 or vice versa) may be time consuming, complicated, and/or expensive process/operation. In addition, creating a combined environment that duplicates both a first environment and a second environment is also expensive, time consuming, and complicated. Thus, duplicating the one environment inside of another environment or creating a combined environment may be done at a final site or location (e.g., at a customer site or location). Because duplicating one environment inside of another environment and/or creating a combined environment is difficult time consuming, and/or expensive, it may be difficult to test the operations and/or interactions of application 112 and 122.

The embodiments, implementations, and/or examples described herein provide a communication bridge that may allow the operations and/or interactions of application 112 and 122 to be tested without creating a combined environment or duplicating one environment within another environment. The communicating bridge may allow each application to execute within its own separate environment but still communicate with each other via API function calls. This allows the separate applications to operate as if they were within the same environment and/or computing device.

In one embodiment, the bridge component 111 may determine that a communication bridge (e.g., communication bridge 161 or 162 should be established between application 112 and application 122. As discussed above, the application 112 is within environment 115 (e.g., a first environment, a computing environment, an infrastructure, etc.) and application 122 is within a second environment 125 (e.g., a second environment, a computing environment, an infrastructure, etc.).

In one embodiment, the bridge component 111 may determine that the communication bridge between application 112 and application 122 should be established based on user input. For example, the bridge component 111 may receive user input (or some other input/message) indicating that the communication bridge should be established between application 112 and application 122.

In one embodiment, the bridge component 111 may transmit a message, a link (e.g., a uniform resource link (URL)), an identifier (e.g., a uniform resource identifier (URI)), etc., to the computing device 120. For example, the bridge component 111 may transmit a message that includes a link to the computing device 120. The message may indicate that the communication bridge should be established between application 112 and application 122. When the computing device 120 receives the message, the bridge component 121 may activate, select, click, etc., the link to establish communication bridge.

In one embodiment, the bridge component 121 may determine that the communication bridge between application 112 and application 122 should be established based on a message received from another computing device (e.g., computing device 120 or 130). For example, the bridge component 121 may a message that includes a link from bridge component 111. The bridge component 121 may determine that a communication channel should be established based on the message.

In one embodiment, bridge component 111 may establish the communication bridge between application 112 and application 122. The communication bridge between application 112 and application 122 may be a set, group, collections, etc., of communication channels between the application 112 and the application 122. In some embodiments, the communication channels may be logical channels. For example, the communication channels may be logical groups of data channels. In other embodiments, the communication channels may also be physical channels. For example, each communication channel may be a different IP address and/or port number.

In one embodiment, each communication channel may be associated with an application programming interface (API) function of application 112 and/or application 122. For example, applications 112 and 122 may each be associated with a set of API functions (e.g., one or more function calls, remote procedure calls (RPCs), etc.). The API functions may be provided by the applications 112 and 122 to allow for various operations, functions, actions, methods, etc., to be performed. For example, an API function may be used to cause application 112 to perform a particular action (e.g., add a user, place an order, read data from a storage location, write data to a storage location, etc.). Each communication channel may be associated with one or more API functions. Associating a communication channel with one or more API functions may allow the associated communication channel to communicate (e.g., transmit/receive) data between the applications 112 and 122, and to cause applications 112 and 122 to perform particular operations, actions, etc.

In one embodiment, the communication bridge 161 (illustrated by the dotted line) may be a direct network connection established between computing devices 110 and 120, where applications 112 and 122 are located, respectively. A direct network connection may be a connection between two devices where the two devices are able to address or communicate with each other by using internet protocol (IP) addresses, hostnames (e.g., a domain name server (DNS) name), or other network identifiers.

In another embodiment, the communication bridge may be an indirect network connection established between computing devices 110 and 120. An indirect network connection may be a connection that is routed through an intermediary device, such as server 150. For example, an indirection connection may be used when security and/or network protocols (e.g., ports are blocked, network address translation (NAT) prevents packets from reaching device, etc.) in one or more of the environments 115 and 125 will not allow computing devices 110 and 120 to communicate with each other based on IP address, hostnames, etc. An indirect connection may include two (or more) network connections. For example, communication bridge 162 may include an indirect connection may include a first network connection between computing device 110 (e.g., application 112) and server 150, and may also include a second network connection between server 150 and computing device 120 (e.g., application 122).

In one embodiment, the bridge component 111 may determine that the application 112 should communicate data with application 122. For example, the application 112 may want the application 122 to perform an action. The application 112 may call, invoke, use, etc., an API function of application 122 to instruct, cause, etc., application 122 to perform the action. The bridge component 111 may detect or determine that the API function of application 122 was invoked and may determine that the application 112 should communicate data with application 122. In another example, the application 122 may want the application 112 to perform an action. The application 122 may call, invoke, use, etc., an API function of application 112 to instruct, cause, etc., application 112 to perform the action. The bridge component 111 receive the API function call from the application 122 and may determine that the application 112 should communicate data with application 122.

In one embodiment, the bridge component 111 may identify a communication channel of the communication bridge (e.g., communication bridge 161A, communication bridge 161B, etc.) based on determining that the application 112 should communicate data with application 122. For example, if application 112 is calling/invoking an API function of application 122 (e.g., a request from application 112 to interact with application 122 is received), the bridge component 111 may identify a communication channel of the communication bridge that is associated with that particular API function of application 122. The bridge component 111 may use the identified communication channel to transmit data for the API function of application 122 (e.g., input parameters, instructions, or other data used by application 122 to perform the action) to the application 122 via the associated communication channel of the communication bridge. In another example, if application 122 is calling/invoking an API function of application 112 (e.g., a request from application 122 to interact with application 112 is received), the API function of application 112 is associated with a particular communication channel of the communication bridge. The bridge component 111 may identify a particular communication channel (of the communication bridge) because data, messages, parameters, etc., for the API function of application 112 may be received via the communication channel from the application 122. The bridge component 111 may execute the API function of application 112 (or instruct application 12 to execute/perform the API function) and may transmit the results of the API function to application 122 via the identified communication channel.

The bridge component 111 may also perform operations similar to the operations described above with respect to application 122. For example, the bridge component 111 may establish another communication bridge 163 between application 112 and application 132. Application 132 may be on computing device 130 (e.g., a third computing device) which is located in environment 135 (e.g., a third environment). The bridge component 111 may receive a request from the application 112 to interact with application 132. For example, the bridge component 111 may determine that application 112 is invoking, calling, etc., an API function of application 132. The bridge component 111 may identify a communication channel in the communication bridge 163. For example, the bridge component 111 may identify the communication bridge 163 that is associated with the API function of application 132. The bridge component 111 may communicate (e.g., transmit data) with the application 132 via the identified communication channel of communication bridge 163. For example, transmit the data, parameters, etc., used by the API function of the application 132 via the identified communication channel.

Although FIG. 1 depicts high-level components of an illustrative example of a system architecture 100, one skilled in the art will appreciate that other architectures for a system architecture 100 are possible, and that the implementation of a computer system utilizing examples of the disclosure are not necessarily limited to the specific architecture depicted by FIG. 1. For example, different numbers and/or configurations of communication bridges may be used in other embodiments. Instead of one communication bridge between application between application 112 and application 122, two communication bridges may be used (e.g., one for API function calls from application 112 to application 122 and one for API function calls from application 122 to application 112). In another example, multiple bridges may be established between application 112 and multiple applications on computing device 120 (not illustrated in FIG. 1).

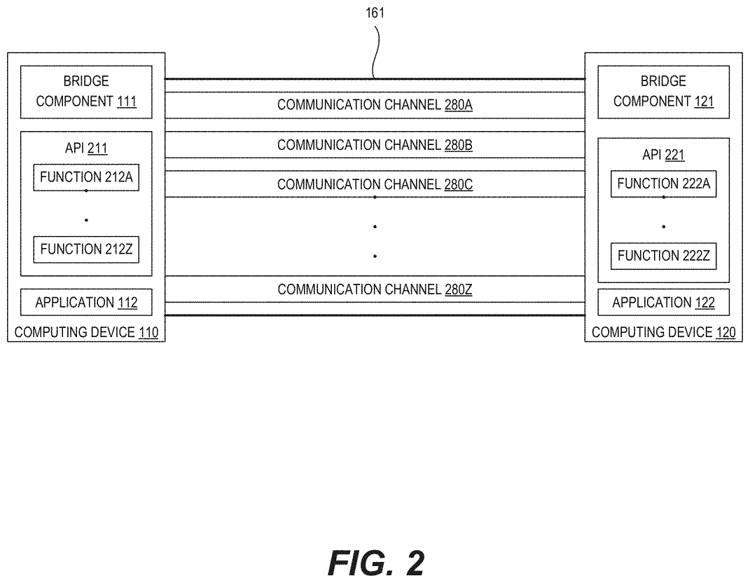

FIG. 2 is a diagram that illustrates an example communication bridge 161, in accordance with some embodiments of the present disclosure. As discussed above, computing device 110 may be located within a first environment (e.g., environment 115) and computing device 120 may be located within a second environment (e.g., environment 125).

Application 112 may be associated with API 211. The API 211 may be type of communication and/or software interface that allows other applications to communicate with application 112 and/or to cause application 112 to perform various operations, functions, actions, etc. The API 211 includes one or more API functions 212A through 212Z. Each API function 212A through 212Z may be invoked, called (e.g., via a RPC), etc., to cause the application 112 to perform a function/operation.

Application 122 may be associated with API 221. The API 221 may be type of communication and/or software interface that allows other applications to communicate with application 122 and/or to cause application 122 to perform various operations, functions, actions, etc. The API 221 includes one or more API functions 222A through 222Z. Each API function 222A through 222Z may be invoked, called (e.g., via a RPC), etc., to cause the application 112 to perform a function/operation.

The communication bridge 161 may include a set, a group, etc., of communication channels, as discussed above. For example, the communication bridge 161 includes communication channels 280A through 280Z, as illustrated in FIG. 2. Each of the communication channels 280A through 280Z may be associated with one or more of the API functions 212A through 212A and 222A through 222Z. For example, a communication channel 280A may be associated with API functions 212A and 212B. In another example, a first subset of the communication channels 280A through 280Z may be associated with API functions 212A through 212Z and a second subset of the communication channels 280A through 280Z may be associated with API functions 222A through 222Z.

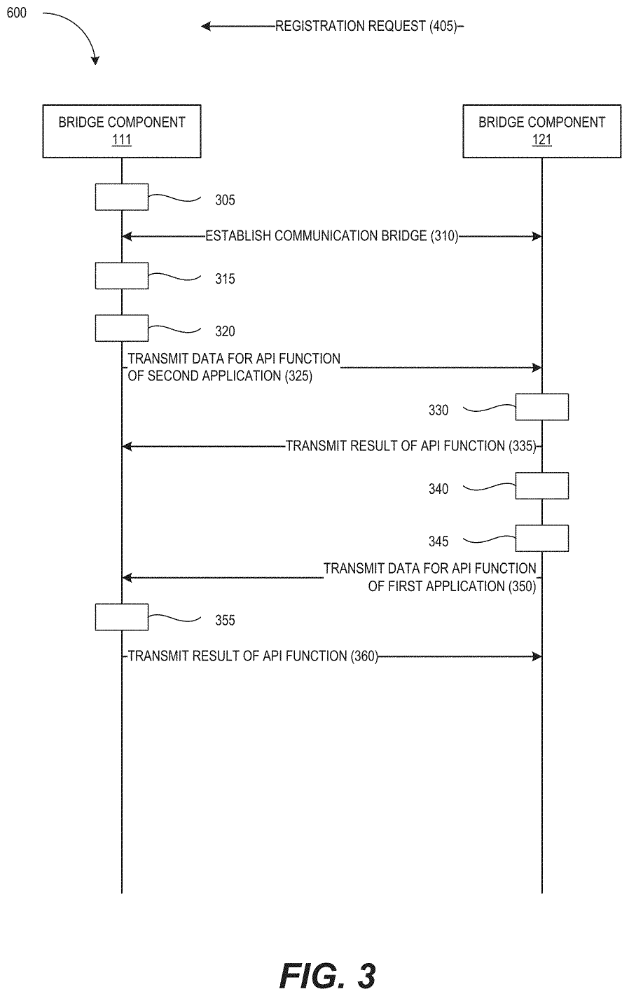

FIG. 3 illustrates an example sequence diagram 300 which illustrates operations (e.g., including communications) that may be performed by one or more bridge components 111 and 121, in accordance with some embodiments of the present disclosure. As discussed above, the bridge components 111 and 121 may establish a communication bridge (or multiple communication bridges) between two applications (e.g., applications 112 and 122 illustrated in FIG. 1). The two applications (and the computing devices where they are respectively located) may be in different environments (e.g., different computing environments, different network environments, different locations, etc.).

At operation 305, the bridge component 111 may determine that a communication bridge should be established between a first application (e.g., application 112 illustrated in FIG. 1) and a second application (e.g., application 122 illustrated in FIG. 1). For example, user input may be received (via an interface such as a graphical user interface (GUI), a command line interface (CLI), etc.) indicating that the communication bridge should be established between the first application and the second application.

At operation 310, the bridge component 111 may establish the communication bridge with the bridge component 121. For example, the bridge component 111 may transmit a message, link, etc., to the bridge component 121 indicating that the communication bridge should be established. The bridge component 111 may create, setup, include, etc., communication channels for the API functions of the first application in the communication bridge. In addition, the bridge component 121 may also create, setup, include, etc., the communication channels for the API functions of the second application in the communication bridge, in response to receiving the message, link, etc., from the bridge component 111.

At operation 315, the bridge component 111 may determine that the first application should communicate data (e.g., interact) with the second application. For example, the bridge component 111 may determine, detect, etc., that the first application has invoked, called, etc., an API function of the second application (e.g., the bridge component 111 may intercept the API function call).

At operation 320, the bridge component 111 may identify a first communication channel of the communication bridge. For example, the bridge component 111 may identify, select, determine, etc., the communication channel that is associated with the API function of the second application. At operation 325, the bridge component 111 may transmit data to the second application. For example, the bridge component 111 may transmit data to call, invoke, execute, etc., the API function of second application (e.g., may transmitted input parameters, instructions, or other data used by the second application).

At operation 330, the bridge component 121 may forward the data to the second application so that the second application may perform the API function requested by the first application (at block 315), or may invoke/call the API function of the second application. At block 335, the bridge component 121 may optionally send a result (e.g., a message or some other data indicating the result) of the API function. For example, the bridge component 121 may identify the communication channel where the request for the API function call was received (e.g., the channel used by bridge component 111 to transmit the API function call) and may use the same communication channel to transmit the result.

At operation 340, the bridge component 121 may determine that the second application should communicate data (e.g., interact) with the first application. For example, the bridge component 121 may determine, detect, etc., that the second application has invoked, called, etc., an API function of the first application (e.g., the bridge component 121 may intercept the API function call).

At operation 345, the bridge component 111 may identify a second communication channel of the communication bridge. For example, the bridge component 121 may identify, select, determine, etc., the communication channel that is associated with the API function of the first application. At operation 350, the bridge component 121 may transmit data to the second application. For example, the bridge component 121 may transmit data to call, invoke, execute, etc., the API function of second application (e.g., may transmitted input parameters, instructions, or other data used by the second application).

At operation 355, the bridge component 111 may forward the data to the first application so that the first application may perform the API function requested by the second application (at block 340), or may invoke/call the API function of the first application. At block 360, the bridge component 111 may optionally send a result (e.g., a message or some other data indicating the result) of the API function. For example, the bridge component 111 may identify the communication channel where the request for the API function call was received (e.g., the channel used by bridge component 121 to transmit the API function call) and may use the same communication channel to transmit the result.

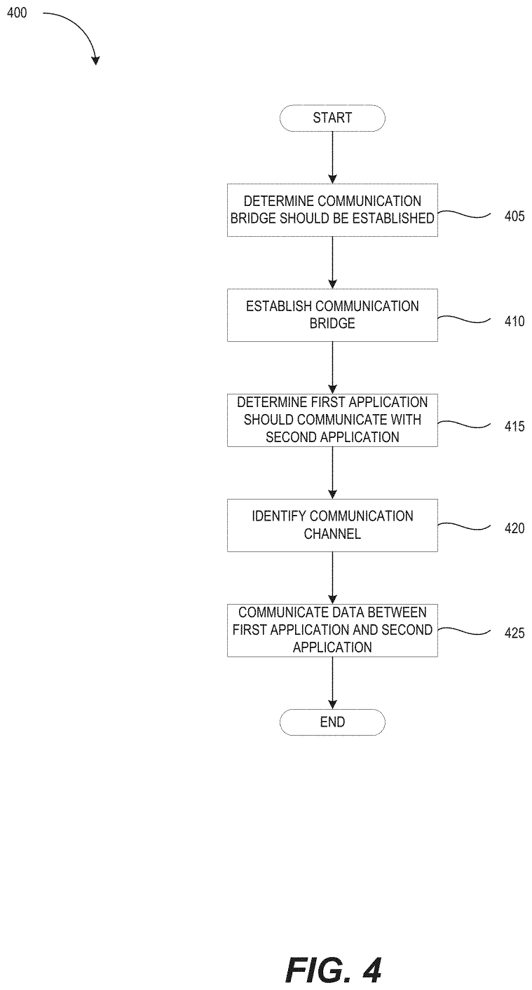

FIG. 4 is a flow diagram of a method 400 to communicate data between applications, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof on the various described devices (e.g., client device 110 of FIG. 1). In some embodiments, at least a portion of method 400 may be performed by a bridge component (e.g., bridge components 111, 121, and 131 illustrated in FIG. 1).

With reference to FIG. 4, method 400 illustrates example functions used by various embodiments. Although specific function blocks (e.g., operations) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 405 where the processing logic determines that a communication bridge should be established between a first application and a second application. For example, the processing logic may receive user input indicating that the communication bridge should be established. As discussed above, the first application and the second application may be located in different computing devices and/or in different environments. At block 410, the processing logic may establish the communication bridge. For example, the processing logic may create communication channels and may transmit a message, link, etc., to another application/bridge component.

At block 415, the processing logic may determine that the first application should communicate (e.g., transmit/receive data) with the second application. For example, the processing logic may determine that the first application has invoked, called, etc., and API function of the second application. At block 420, the processing logic may identify a communication channel of the communication bridge. For example, the processing logic may identify a communication channel associated with the API function of the second application. At block 425, the processing logic may communicate data between the first application and the second application. For example, the processing logic may transmit parameters, data, used to invoke the API function. In another example, the processing logic may receive results of the API function.

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a network 520. Data storage device 518 may include a computer-readable storage medium 528 on which may be stored one or more sets of instructions 525 that may include instructions for a bridge component (e.g., bridge component 111 illustrated in FIG. 1), for carrying out the operations described herein, in accordance with one or more aspects of the present disclosure. Instructions 525 may also reside, completely or at least partially, within main memory 504 and/or within processing device 502 during execution thereof by computing device 500, main memory 504 and processing device 502 also constituting computer-readable media. The instructions 525 may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “reading,” “routing,” “updating,” “connecting,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. A method, comprising:
determining that a communication bridge should be established between a first application located within a first computer network and a second application within a second computer network that is different from the first computer network, wherein the communication bridge comprises a set of communication channels;
establishing the communication bridge between the first application and the second application;
determining, based on the first application, which operates in the first computer network, invoking a function of the second application, which operates in the second computer network, that the first application should communicate data with the second application;
identifying a first communication channel from the set of communication channels based on the determination that the first application should communicate data with the second application; and
communicating data between the first application and the second application via the first communication channel.

2. The method of claim 1, wherein each communication channel of the set of communication channels is associated with an application programming interface (API) function of the first application or the second application.

3. The method of claim 1, wherein:
the set of communication channels comprises a first subset of communication channels and a second subset of communication channels;
each communication channel of the first subset of communication channels is associated with an application programming interface (API) function of the first application; and
each communication channel of the second subset of communication channels is associated with an application programming interface (API) function of the second application.

4. The method of claim 1, wherein determining that the communication bridge should be established between the first application and the second application comprises:
receiving user input indicating that the communication bridge should be established between the first application and the second application.

5. The method of claim 4, further comprising:
transmitting a message to a computing device where the second application is located, wherein the message indicates that the communication bridge should be established between the first application and the second application.

6. The method of claim 1, wherein determining that the communication bridge should be established between the first application and the second application comprises:
receiving a message from the first application indicating that the communication bridge should be established between the first application and the second application.

7. The method of claim 1, wherein the first application and the second application are configured to operate within a same computing device.

8. The method of claim 1, wherein the communication bridge between the first application and the second application comprises a direct network connection.

9. The method of claim 1, wherein the communication bridge between the first application and the second application comprises
a first network connection between the first application and a server;
a second network connection between the second application and the server.

10. The method of claim 1, further comprising:
establishing a second communication bridge between the first application and a third application within a third computer network, wherein the second communication bridge comprises a second set of communication channels;
receiving a request from the first application to interact with the third application;
identifying a second communication channel from the second set of communication channels based on the request to interact with the second application; and
transmitting data to the third application via the second communication channel.

11. The method of claim 1, further comprising:
receiving a second request from the first application to interact with the second application;
identifying a second communication channel from the set of communication channels based on the second request to interact with the second application; and
transmitting data to the second application via the first communication channel.

12. The method of claim 1, further comprising:
receiving a second request from the second application to interact with the first application;
identifying a second communication channel from the set of communication channels based on the second request to interact with the second application; and
transmitting data to the second application via the first communication channel.

13. An apparatus, comprising:
a memory; and
a processing device, operatively coupled to the memory, to:
determine that a communication bridge should be established between a first application located within a first computer network and a second application within a second computer network that is different from the first computer network, wherein the communication bridge comprises a set of communication channels;
establish the communication bridge between the first application and the second application;
determine, based on the first application, which operates in the first computer network, invoking a function of the second application, which operates in the second computer network, that the first application should communicate data with the second application;
identify a first communication channel from the set of communication channels based on the determination that the first application should communicate data with the second application; and
communicate data between the first application and the second application via the first communication channel.

14. The apparatus of claim 13, wherein each communication channel of the set of communication channels is associated with an application programming interface (API) function of the first application or the second application.

15. The apparatus of claim 13, wherein:
the set of communication channels comprises a first subset of communication channels and a second subset of communication channels;
each communication channel of the first subset of communication channels is associated with an application programming interface (API) function of the first application; and
each communication channel of the second subset of communication channels is associated with an application programming interface (API) function of the second application.

16. The apparatus of claim 13, wherein to determine that the communication bridge should be established between the first application and the second application the processing device is further to:
receive user input indicating that the communication bridge should be established between the first application and the second application.

17. The apparatus of claim 16, wherein the processing device is further to:
transmit a message to a computing device where the second application is located, wherein the message indicates that the communication bridge should be established between the first application and the second application.

18. The apparatus of claim 13, wherein to determine that the communication bridge should be established between the first application and the second application the processing device is further to:
receive a message from the first application indicating that the communication bridge should be established between the first application and the second application.

19. The apparatus of claim 13, wherein the first application and the second application are configured to operate within a same computing device.

20. A non-transitory computer-readable storage medium having instructions stored thereon that, when executed by a processing device, cause the processing device to:
determine that a communication bridge should be established between a first application located within a first computer network and a second application within a second computer network that is different than the first computer network, wherein the communication bridge comprises a set of communication channels;
establish the communication bridge between the first application and the second application;
determine, based on the first application, which operates in the first computer network, invoking a function of the second application, which operates in the second computer network, that the first application should communicate data with the second application;
identify a first communication channel from the set of communication channels based on the determination that the first application should communicate data with the second application; and
communicate data between the first application and the second application via the first communication channel.
